(19) United States
(12) Patent Application Publication
(10) Pub. No.: US 2009/0084722 A1
(43) Pub. Date: Apr. 2, 2009

(54) Core adapter

(76) Inventors: Welby S. Atteberry, Albion, IL (US); Jason Snider, Richland, IL (US)

Correspondence Address: Olson & Cepuritis, LTD., 20 NORTH WACKER DRIVE, 36TH FLOOR, CHICAGO, IL, 60606, US

(21) Appl. No.: 11/904,894

(22) Filed: Sep. 28, 2007

(51) Int. Cl. B01D 25/19

(52) U.S. Cl. 210/230

(57) ABSTRACT

An adapter clip is provided for a filter assembly that includes a housing, a specialized replaceable filter element, and an extension and locking mechanism for cooperating with the specialized filter element to preclude operation of the filter assembly without a specialized filter element. The adapter clip will render the extension and locking mechanism inoperative and permit the use of a universal filter element. Also, the use of the adapter clip will enable filter assembly operation without any filter installed, as may be desirable in emergency situations.

### BACKGROUND OF THE INVENTION

This invention pertains to a core adapter for a filter mechanism that includes a housing having a central support with a locking mechanism for permitting only a specified filter to be used with the filter mechanism, said core adapter enabling use of a standard filter mechanism.

There is shown in Maxwell et al U.S. Pat. No. 6,554,139 a filter assembly that includes a housing enclosing a replaceable filter element. A support core in the housing includes an extension and locking assembly. The filter element includes a ring of filtration media with an end cap at each end. The first end cap includes a central opening to receive the support core. The extension and locking assembly prevents the cover of the housing from being attached to the housing body without a proper filter element installed. The extension and locking assembly includes a bypass member and a locking member, which are in locking engagement when a filter element is absent from the housing. The second end cap includes a series of internal protrusions which engage the locking member when the filter element is installed to disengage the bypass member from the support core, and allow the filter element to be inserted and the cover to be installed.

Automobile manufacturers and consumers usually desire more than single source in order to assure adequate supply of product and to obtain better pricing. This is true for many products including the filter element disclosed in the Maxwell et al U.S. Pat. No. 6,554,139.

One alternative suggested to the filter element of the Maxwell et al U.S. Pat. No. 6,554,139 involved providing projections or protrusions on the first end cap for deactivating the support core locking mechanism.

Another alternative was to make the actuating protrusion a part of the support core, but the protrusion was permitted to float and was not affixed to the first or top end cap.

There is a need for a less expensive filter element that can be used with the housing and mounting shown in the Maxwell et al U.S. Pat. No. 6,554,139.

An object of the present invention is to provide a simple solution that is economical and efficient, while permitting the use of a conventional filter element having an annular filter media with end caps secured at the top and bottom.

Another object of the present invention is to provide a core adapter for deactivating the locking mechanism in the support core and enabling the replacement of the specialized filter element including an end cap with protrusions for deactivating the locking mechanism with a less expensive filter element, which does not require such protrusions.

Other objects and advantages of the present invention will be made more apparent hereinafter.

### BRIEF DESCRIPTION OF THE DRAWING

There is shown in the attached drawing a presently preferred embodiment of the present invention, wherein like numerals refer to like elements in the various views and wherein:

FIG. 1 is cross section of a filter mechanism illustrating the core adapter of the present invention in place to lock out the extension and locking mechanism;

FIG. 2 is an exploded perspective view of the core adapter and locking mechanism prior to entry of the core adapter into the extension and locking mechanism;

FIG. 3 is a cross sectional view of the extension and locking mechanism, without the core adapter in place;

FIG. 4 is a cross sectional view of the extension and locking mechanism, as in FIG. 3, illustrating the core adapter in the lockout position;

FIG. 5 is a front view of the core adapter of the present invention; and

FIG. 6 is a side view of the core adapter of the present invention.

### DETAILED DESCRIPTION OF THE PRESENT INVENTION

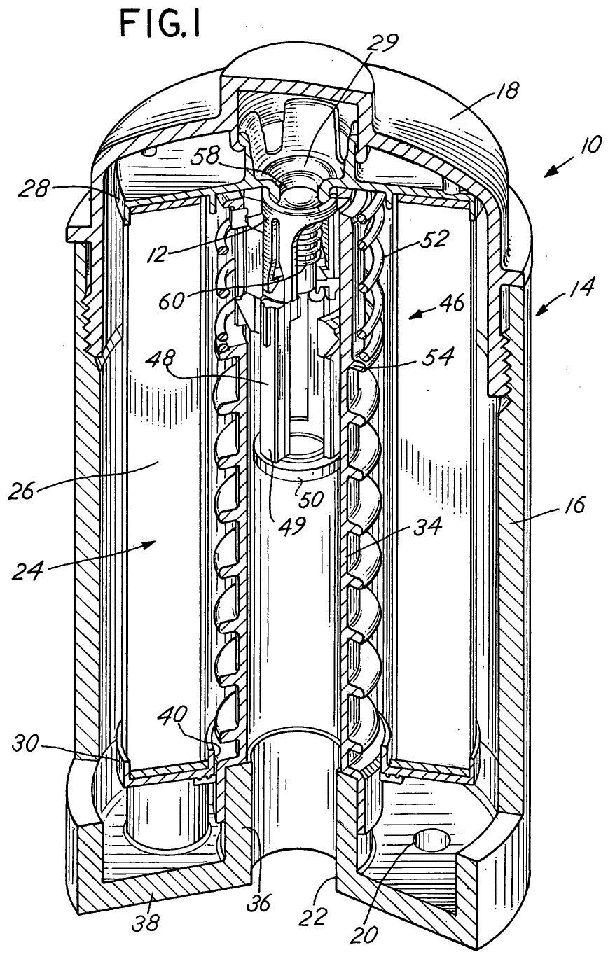

There is shown in FIG. 1 a filter assembly 10, with the core adapter 12 of the present invention in place in the extension and locking mechanism. The filter assembly 10 includes a housing means 14 having a housing body 16 and a housing cover 18, suitably secured to the housing body 16, for example, by a threaded connection. External threads on an annular depending portion of the housing cover 18 engage with internal threads in the housing body 16.

The housing body is provided with an inlet port 20 and an outlet port 22. It will be understood that the fluid to be filtered, for example, diesel fuel, will flow from the engine (not shown) to the filter assembly 10 and enter the inlet port 20. The fluid will pass through the filter element 24, where contaminants or particulate material will be removed, and then filtered fluid will exit the housing body 16 from the outlet port 22 for return to the engine.

The filter assembly 10 includes a replaceable filter element 24 comprising a ring of filtration media 26, and end caps 28, 30 sealingly bonded at each end of the filtration media 26, for example, by an adhesive. The filtration media 26 may comprise a conventional pleated paper material.

An internal support core 34 is fixed to an upright annular portion 36 of the end wall 38 of the filter housing body 16, and the end cap 30 of the filter element 24 includes a central opening 40, such that the filter element 24 can be removably received over the support core 34. The support core 34 provides internal support for the filter element 24, so that the filter element 24, if desired, can be made of only material which is easily incinerated.

An extension and locking assembly 46 is provided with the support core 34. The extension and locking assembly 46 of the U.S. Pat. No. 6,554,139 operates to prevent the housing cover 18 of the housing means 14 from being attached to the housing body 16 without a predetermined replaceable filter element installed in the housing, or without a filter element in the housing. The U.S. Pat. No. 6,654,139 is incorporated by reference. With reference to FIGS. 1 and 3, the extension and locking assembly 46 includes a bypass member 48 and a locking member 50. The bypass member 48 is closely and slideably received in the locking member 50, while the locking member 50 is closely and slideably received in the support core 34. A main spring extends between a shoulder 54 on the support core 34 and the enlarged head of the locking member 50 to bias the locking member 50 and bypass member 48 outwardly from the support core 34.

When the locking member 50 and bypass member 48 are in their outer position in the device shown in the U.S. Pat. No. 6,554,139 the distal inner end of the locking member 50 urges the distal inner end of the bypass member 48 radially outward against the inner surface of the support core 34. The support core 34 may include an annular step or shoulder along its inner surface, and the distal inner end of the bypass member may engage the step to prevent the extension and locking assembly 46 from being pushed inwardly into the support core 34. The extension and locking assembly 46 of the U.S. Pat. No. 6,554,139 is intended to be long enough such that the housing cover 18 cannot be attached to the housing body when the extension and locking assembly 46 is in its outer position.

The enlarged head of the bypass member 48 includes a series of openings which allow access to the enlarged head of the locking member 50. The openings are strategically placed, and the end cap of the U.S. Pat. No. 6,554,139 (opposite from the end cap of the filter element with the central opening) has a series of protrusions that extend axially inward from the end cap, in orientation with the openings. When the filter element 24 is installed over the support core 34, the protrusions extend through the openings in the head of the bypass member 48 and engage the head of the locking member 50. The protrusions force the locking member axially inward, and in so doing, move the distal inner end of the locking member 50 away from the distal inner end of the bypass member 48. This allows the distal inner end of the bypass member 48 to disengage from the step in the support core, and the locking member 50 and bypass member 48 to slide inwardly (retract) into the support core 34. In its inner position, the extension and locking assembly 46 allows the filter element 24 to be properly located in the filter housing 14, and the housing cover 18 to be attached to the housing body 16.

Bypass valve 56 (FIGS. 1 and 3) includes an enlarged head 57, which cooperates with an opening 58 in the end cap 28 to provide for bypass of the filter element, if needed, in operation of the filter assembly and a pair of depending or axially-extending arms or fingers 59, with a hook or catch 61 engaging locking member 50. The bypass spring 60 creates the force required to hold the bypass member 48 and the locking member 50 together. The locking member 50 causes the legs 49 of the bypass member 48 to flare out and create the locking functionality.

In operation, with the filter element 24 is located in the housing means 14, the end cap 28, more specifically, the flange 29 of the end cap 28, engages and seals against the enlarged head 57, thereby preventing fluid from bypassing the filter element 24. When an over-pressure situation exists within the housing means 14, such as, when the filter element 26 becomes clogged or plugged, the pressure forces the bypass valve 56 inwardly against the bypass spring 60, thereby creating a flow path between the end cap 28 and the bypass member 48, and allowing fluid to bypass the filter element 24.

In the patented design described only a special replaceable filter element with a specific arrangement of protrusions on an end cap can be used with the support core and filter housing. The source of supply is limited to effectively a single source and costs to the consumer are increased due to lack of competitive pressure in the market place.

To overcome these problems, applicants conceived of a core adapter or adapter clip to disengage the extension and locking assembly 46 and permit use of a standard or conventional filter having an annular pleated filter media, with an end cap bonded or secured to the ends.

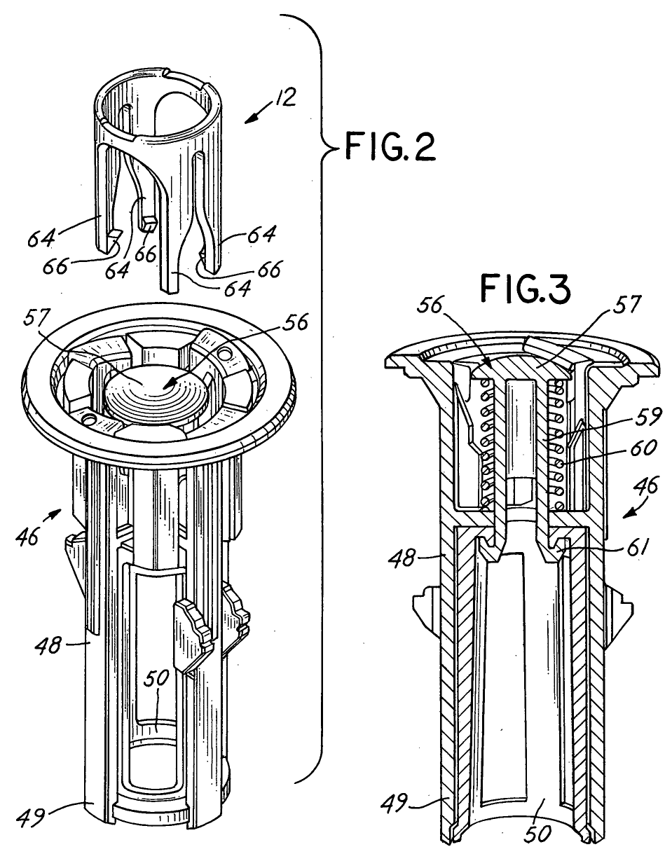

In FIG. 2 there is shown an adapter clip 12 about to be introduced into the extension and locking mechanism 46. As afore-noted, in normal use of the extension and locking mechanism as described in the U.S. Pat. No. 6,554,139 the locking member 50 causes the legs of the bypass member 48 to flare out and create the locking feature. The adapter clip 12 is constructed and arranged to engage within the extension and locking member 46 to overcome the force of the spring 60 and allow the legs 49 of the bypass member 48 to relax from their flared state. The adapter clip 12 is intended to remain in place and continuously deactivate the extension and locking mechanism 46.

With reference to FIGS. 2, 5, and 6, it is seen that the adapter clip or core adapter 12 is generally an annular member 62 having a plurality of arms or fingers 64 extending downwardly from the top thereof and having a catch or barbs 66 at the bottom of each arm or finger 64. The adapter clip or core adapter may be molded from a suitable plastic, for example, a nylon, such as PA6.6, such that the arms 64 have some resiliency. The adapter clip 12 can have differently contoured arms 64 and catches or barbs 66 from those shown in FIGS. 2, 4, 5, and 6 to accomplish the desired results, for example, the arms 64 can have oval or circular transverse cross sections. The shape of the arms 64 and the length of the arms 64 can be varied so long as the core adapter 12 is able to accomplish the desired function. The arms 64 are contoured or formed so as to facilitate entry between the bypass member 48 and the locking member 50. As seen in the front view (FIG. 5), the arms 64 of the core adapter 12 are essentially parallel to one another. As seen in the side view (FIG. 6), the adjacent arms 64 are generally parallel at the bottom, taper outwardly or widen in the mid section or region and are then generally parallel to one another.

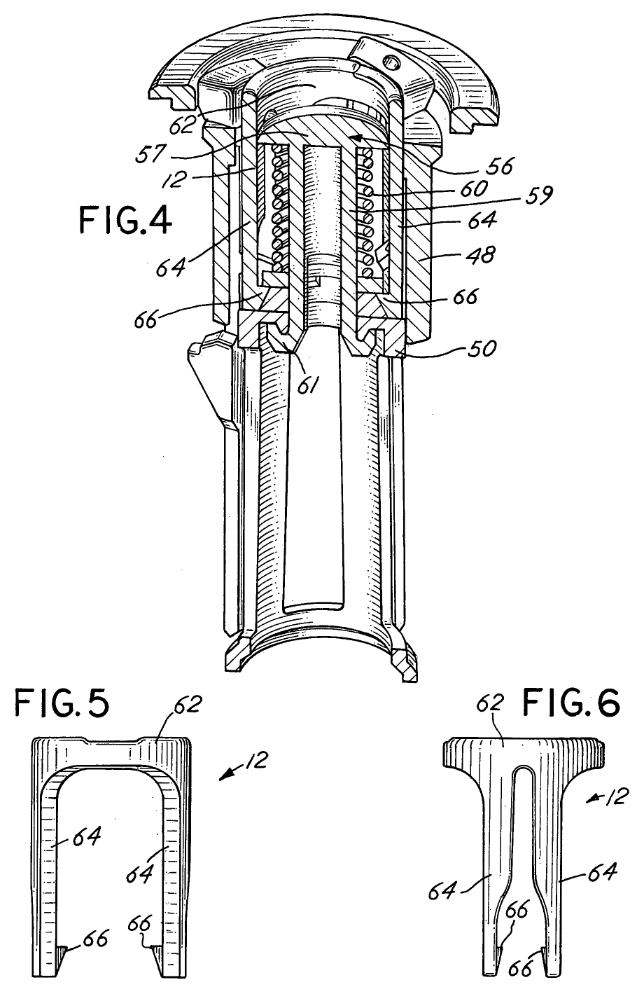

FIG. 4 shows the adapter clip 12 in place in the extension and locking mechanism 46 to retain same in the relaxed or inoperative state. The adapter clip 12 is inserted into openings in the extension and locking mechanism 46 until the barbs 66 on the ends of the arms 64 engage or lock between the bypass member 48 and the locking member 50. This pushes the bypass member 48 and the locking member 50 apart, allowing the legs of the locking member 50 to relax, unlocking the extension and locking mechanism 46.

With the core adapter 12 installed the filter assembly will work with a filter element that does not have a series of protrusions on the end cap, as in the U.S. Pat. No. 6,554,139 patent. The core adapter 12 will allow operation without any filter installed, as may sometimes be desirable in an emergency situation.

While we have shown a presently preferred embodiment of the present invention it will be understood by person skilled in the art that the invention may be otherwise embodied within the scope of the following claims.

We claim:

1. A core adapter for a filter assembly including a filter element comprising an annular filter media with end plates bonded to the ends and having an extension and locking assembly comprising an annular member having a plurality of arms depending therefrom, the arms being constructed and arranged to cooperate with the extension and locking mechanism for rendering same inoperative.

2. A core adapter as in claim 1, wherein the plurality of arms comprises four arms.

3. A core adapter as in claim 1, including a barb at the end of each arm.

4. For use in a filter assembly that includes a housing having a housing body and a cover couple thereto, a support core in the housing, an extension and locking assembly cooperating with the support core, and a replaceable filter element, the replaceable filter element including a ring of filtration media with an end cap at each end, one end cap provided with a central opening to receive the support core, the extension and locking assembly preventing the cover of the housing from being attached to the housing body without a filter element installed in the housing, the extension and locking assembly including a bypass member and a locking member, which are in locking engagement when a filter element is absent from the housing, the improvement comprising a core adapter having a body and arm means extending axially therefrom, the core adapter being constructed and arranged to engage and disable the extension and locking assembly, whereby the filter assembly can accept a conventional replaceable filter element.

5. A filter assembly as in claim 4, wherein the arm means of the core adapter has at least two arms for engaging and disabling the extension and locking assembly.

6. A filter assembly as in claim 4, wherein the arm means of the core adapter has four arms for engaging and disabling the extension and locking assembly.

7. A filter assembly as in claim 4, wherein the arm means have barbs at the free ends thereof for engaging the extension and locking means.
